(19) United States
(12) Patent Application Publication
(10) Pub. No.: US 2023/0360374 A1
(43) Pub. Date: Nov. 9, 2023

(54) INFORMATION PROCESSING DEVICE, INFORMATION PROCESSING METHOD, AND PROGRAM

(71) Applicant: SONY SEMICONDUCTOR SOLUTIONS CORPORATION, KANAGAWA (JP)

(72) Inventor: KAZUYUKI OKUIKE, KANAGAWA (JP)

(21) Appl. No.: 18/246,246

(22) PCT Filed: Sep. 16, 2021
(86) PCT No.: PCT/JP2021/034033

§ 371 Date: Mar. 22, 2023

(30) Foreign Application Priority Data
Sep. 30, 2020 (JP) 2020-165562

(51) Int. Cl. G06V 10/774; H04N 23/76; H04N 23/73; G06T 7/80; H04N 23/61; G06V 10/82

(52) U.S. Cl. CPC G06V 10/7747; H04N 23/76; H04N 23/73; G06T 7/80; H04N 23/61; G06V 10/82; G06T 2207/20084; G06T 2207/20081

(57) ABSTRACT

The present technology relates to an information processing device, an information processing method, and a program for achieving improvement of detection accuracy of object detection using an inference model. At least either a parameter associated with imaging or a parameter associated with signal processing for an input image obtained by the imaging is changed according to a type of an object detected from the input image by an inference model that uses a neural network.

### TECHNICAL FIELD

The present technology relates to an information processing device, an information processing method, and a program, and particularly to an information processing device, an information processing method, and a program for improving detection accuracy of object detection using an inference model.

### BACKGROUND ART

PTL 1 discloses a technology which achieves appropriate exposure without influence imposed by a color, such as a color of eyes, in a case where a main subject is a human.

### CITATION LIST

### Patent Literature

[PTL 1]
Japanese Patent Laid-open No. 2012-63385

### SUMMARY

### Technical Problem

In a case of performing object detection from an input image with use of an inference model which uses a neural network, appropriate object detection may be difficult to achieve in some cases, depending on types of objects to be detected, even under the same detection condition.

The present technology has been developed in consideration of the abovementioned circumstances, with an aim to improve detection accuracy of object detection which uses an inference model.

### Solution to Problem

An information processing device according to the present technology is directed to an information processing device, or a program for causing a computer to function as such an information processing device, the information processing device including a processing unit that changes at least either a parameter associated with imaging or a parameter associated with signal processing for an input image obtained by the imaging, according to a type of an object detected from the input image by an inference model that uses a neural network.

An information processing method according to the present technology is directed to an information processing method that changes at least either a parameter associated with imaging or a parameter associated with signal processing for an input image obtained by the imaging, according to a type of an object detected from the input image by an inference model that uses a neural network.

According to the present technology, at least either a parameter associated with imaging or a parameter associated with signal processing for an input image obtained by the imaging is changed according to a type of an object detected from the input image by an inference model that uses a neural network.

### BRIEF DESCRIPTION OF DRAWINGS

FIG. 1 is a block diagram depicting a configuration example of an imaging device to which the present technology is applied.

FIG. 2 is a diagram depicting a flow of processes and information associated with exposure control of the imaging device depicted in FIG. 1.

FIG. 3 is a diagram illustrating some of camera control parameters.

FIG. 4 is a diagram depicting an example of a result of object detection by an inference model.

FIG. 5 is a diagram depicting an example of a relation between an object detection region and a photometric area.

FIG. 6 is a diagram depicting an example of a relation between a goal exposure amount and brightness of a target image in a case of exposure control according to the goal exposure amount.

FIG. 7 is a diagram depicting an example of inference result data.

FIG. 8 is a diagram depicting an example of main detection object data extracted from the inference result data in FIG. 7.

FIG. 9 is a diagram explaining a process performed by a relearning data transmission determination unit.

FIG. 10 is a diagram explaining another mode of the process performed by the relearning data transmission determination unit.

FIG. 11 is a diagram explaining a second process performed by a relearning unit.

FIG. 12 is a diagram explaining the second process performed by the relearning unit.

FIG. 13 is a block diagram depicting a different configuration example 1 of an exposure control system.

FIG. 14 is a block diagram depicting a different configuration example 2 of the exposure control system.

FIG. 15 is a block diagram depicting a different configuration example 3 of the exposure control system.

FIG. 16 is a block diagram depicting a configuration example of hardware of a computer which executes a series of processes under a program.

### DESCRIPTION OF EMBODIMENT

An embodiment of the present technology will hereinafter be described with reference to the drawings.

<Embodiment of Imaging Device to which Present Technology is Applied>

### (Configuration of Imaging Device 2)

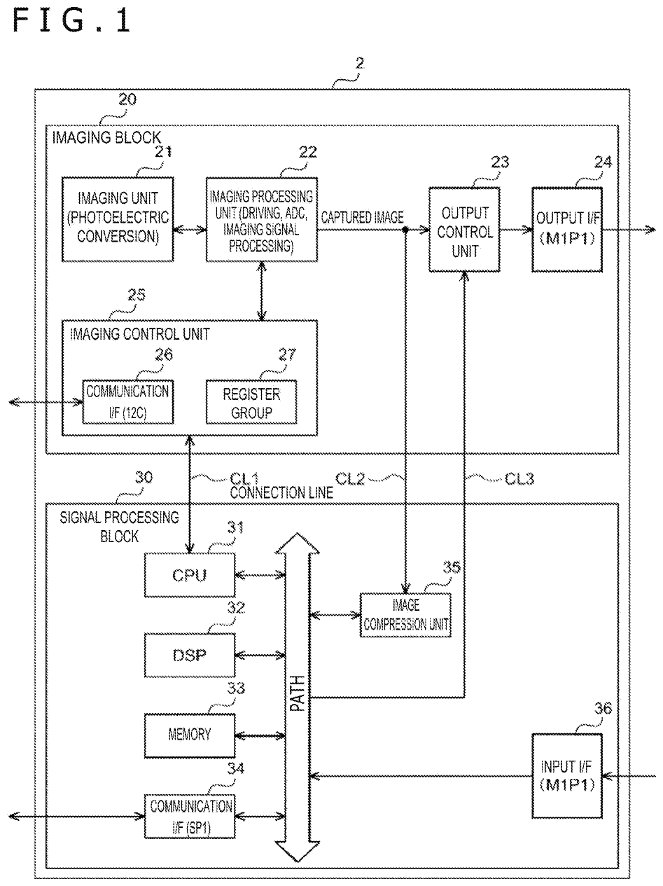

FIG. 1 is a block diagram depicting a configuration example of an imaging device to which the present technology is applied.

In FIG. 1, an imaging device 2 to which the present technology is applied includes an imaging block 20 and a signal processing block 30. The imaging block 20 and the signal processing block 30 are electrically connected to each other via connection lines (internal buses) CL1, CL2, and CL3.

### (Imaging Block 20)

The imaging block 20 includes an imaging unit 21, an imaging processing unit 22, an output control unit 23, an output I/F (Interface) 24, and an imaging control unit 25 to capture images.

The imaging unit 21 is controlled by the imaging processing unit 22. The imaging unit 21 includes an imaging element. An unillustrated optical system forms an image of a subject on a light receiving surface of the imaging element. The image formed on the light receiving surface is photoelectrically converted into an analog image signal by the imaging element, and supplied to the imaging processing unit 22. Note that images captured by the imaging unit 21 may be either color images or grayscale images. Images captured by the imaging unit 21 may be either still images or moving images.

The imaging processing unit 22 performs necessary processing for imaging, such as driving of the imaging unit 21, AD (Analog to Digital) conversion of analog image signals output from the imaging unit 21, and imaging signal processing, under the control of the imaging control unit 25. The imaging signal processing includes noise removal, auto-gain, defect correction, color correction, and others.

The imaging processing unit 22 supplies images of digital signals that have been subjected to processing to the output control unit 23, and to an image compression unit 35 of the signal processing block 30 via the connection line CL2.

The output control unit 23 acquires images from the imaging processing unit 22 and signal processing results supplied from the signal processing block 30 via the connection line CL3. The signal processing results received from the signal processing block 30 are results obtained by signal processing performed by the signal processing block 30 with use of images or the like received from the imaging processing unit 22.

The output control unit 23 supplies, to the output I/F 24, either one of or both the images received from the imaging processing unit 22 and the signal processing results received from the signal processing block 30.

The output I/F 24 outputs images or signal processing results received from the output control unit 23 to the outside.

The imaging control unit 25 includes a communication I/F 26 and a register group 27.

For example, the communication I/F 26 is a communication I/F, such as a serial communication I/F as exemplified by I2C (Inter-Integrated Circuit). The communication I/F 26 exchanges necessary information with an external processing unit.

The register group 27 includes multiple registers. Information given from the outside via the communication I/F 26, information supplied from the imaging processing unit 22, and information supplied from the signal processing block 30 via the connection line CL1 are stored in the register group 27.

Information stored in the register group 27 includes imaging information (camera control parameters), such as parameters associated with imaging and parameters associated with signal processing. For example, the imaging information includes ISO sensitivity (analog gain during AD conversion by the imaging processing unit 22), exposure time (shutter speed), an aperture value, a frame rate, a focus, an imaging mode, a cut-out range, and others.

The imaging control unit 25 controls the imaging processing unit 22 according to imaging information stored in the register group 27 to control, by using the imaging processing unit 22, imaging performed by the imaging unit 21.

Note that results of imaging signal processing performed by the imaging processing unit 22 and output control information associated with output control performed by the output control unit 23 are stored in the register group 27 in addition to the imaging information. The output control unit 23 supplies captured images and signal processing results to the output I/F 24 selectively, for example, according to output control information stored in the register group 27.

### (Signal Processing Block 30)

The signal processing block 30 performs predetermined signal processing by using images or the like obtained by the imaging block 10.

The signal processing block 30 includes a CPU (Central Processing Unit) 31, a DSP (Digital Signal Processor) 32, a memory 33, a communication I/F 34, the image compression unit 35, and an input I/F 36.

Respective components of the signal processing block 30 are connected to each other via a bus, and exchange information with each other as necessary.

The CPU 31 executes a program stored in the memory 33. The CPU 31 controls the respective components of the signal processing block 30, reads and writes information from and to the register group 27 of the imaging control unit 25 via the connection line CL1, and performs other various types of processing by executing the program.

For example, the CPU 31 calculates imaging information by executing the program. The imaging information is calculated using signal processing results obtained by signal processing performed by the DSP 32.

The CPU 31 supplies calculated imaging information to the imaging control unit 25 via the connection line CL1, and stores the imaging information in the register group 27.

Accordingly, the CPU 31 is capable of controlling imaging performed by the imaging unit 21 and imaging signal processing performed by the imaging processing unit 22, according to a signal processing result or the like of an image captured by the imaging unit 21.

The imaging information stored by the CPU 31 in the register group 27 can be provided (output) from the communication I/F 26 to the outside. For example, information associated with a focus or an aperture and included in the imaging information stored in the register group 27 can be provided from the communication I/F 26 to an optical driving system (not depicted).

The DSP 32 executes a program stored in the memory 33. The DSP 32 performs signal processing by using images supplied to the signal processing block 30 via the connection line CL2 and information received by the input I/F 36 from the outside.

The memory 33 includes a SRAM (Static Random Access Memory), a DRAM (Dynamic RAM), or the like. Data and the like necessary for processing to be performed by the signal processing block 30 are stored in the memory 33.

For example, a program received by the communication I/F 34 from the outside, images compressed by the image compression unit 35 and used for signal processing by the DSP 32, results of signal processing performed by the DSP 32, information received by the input I/F 36, and the like are stored in the memory 33.

For example, the communication I/F 34 is a communication I/F, such as a serial communication I/F as exemplified by SPI (Serial Peripheral Interface). The communication I/F 34 exchanges necessary information, such as a program executed by the CPU 31 or the DSP 32, with the outside. For example, the communication I/F 34 downloads a program to be executed by the CPU 31 or the DSP 32 from the outside, and supplies the downloaded program to the memory 33 to store it therein.

Accordingly, the CPU 31 and the DSP 32 are allowed to execute various kinds of processing under the program downloaded by the communication I/F 34.

Note that the communication I/F 34 is capable of exchanging any data with the outside as well as programs. For example, the communication I/F 34 is capable of outputting signal processing results obtained by signal processing performed by the DSP 32 to the outside. Moreover, the communication I/F 34 is capable of outputting to an external device information following instructions from the CPU 31, and is hence capable of controlling the external device in accordance with the instructions from the CPU 31.

Note here that the signal processing results obtained by signal processing performed by the DSP 32 may be written by the CPU 31 to the register group 27 of the imaging control unit 25 rather than being output from the communication I/F 34 to the outside. The signal processing results written to the register group 27 may be output from the communication I/F 26 to the outside. This is applicable to processing results of processing performed by the CPU 31.

The image compression unit 35 compresses images supplied from the imaging processing unit 22 via the connection line CL2. Each of the compressed images has a data volume smaller than a data volume of the image prior to compression.

The image compression unit 35 supplies compressed images to the memory 33 via the bus, and stores the images in the memory 33.

Note that the DSP 32 is capable of performing both signal processing using images received from the imaging processing unit 22 and signal processing using images compressed by the image compression unit 35. The signal processing using compressed images handles a smaller data volume than a data volume of uncompressed images. Accordingly, reduction of a signal processing load and cutting down of a storage capacity of the memory 33 for storing images are achievable.

Note that the image compression unit 35 may be implemented either by software or by dedicated hardware.

The input I/F 36 receives information from the outside. For example, the input I/F 36 acquires sensor data output from an external sensor. The input I/F 36 supplies the acquired sensor data to the memory 33 via the bus, and stores the data in the memory 33.

For example, the input I/F 36 may include a parallel I/F, such as an MIPI (Mobile Industry Processor Interface), or the like, similarly to the output IF 24.

In addition, the external sensor may include a distance sensor for sensing information associated with a distance, for example. Alternatively, the external sensor may include an image sensor for sensing light and outputting an image corresponding to this light, i.e., an image sensor provided separately from the imaging device 2, for example.

The DSP 32 is capable of performing signal processing by using sensor data received from the external sensor and acquired by the input I/F 36.

According to the imaging device 2 that includes one chip and is configured as above, signal processing using uncompressed images (or compressed images) captured by the imaging unit 21 is performed by the DSP 32, and signal processing results of this signal processing and images captured by the imaging unit 21 are output from the output I/F 24.

### (Exposure Control of Imaging Device 2)

### (Exposure Control System)

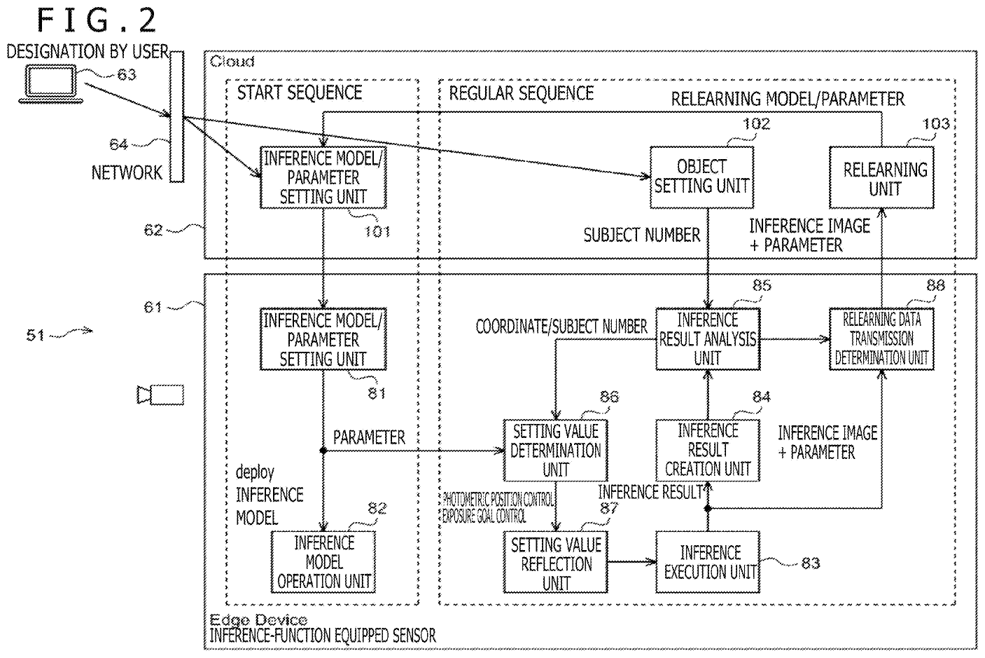

FIG. 2 is a diagram depicting a flow of processes and information associated with exposure control of the imaging device 2 depicted in FIG. 1.

In FIG. 2, the exposure control system 51 captures images by using a DNN (Deep Neural Network) equipped sensor 61 (inference-function equipped sensor). The DNN equipped sensor 61 includes the imaging device 2 depicted in FIG. 1 and equipped with a calculation function using an inference model. For example, the inference model has a DNN structure such as a CNN (Convolutional Neural Network). The DNN equipped sensor 61 achieves object detection (including image recognition) by performing a calculation process using an inference model (DNN) for images obtained by imaging. The DNN equipped sensor 61 achieves appropriate exposure control according to a type (class) of a subject detected by object detection, to control brightness (exposure amount) of images. In such a manner, detection accuracy of object detection by an inference model improves.

The exposure control system 51 performs setup of an inference model and camera control parameters for the DNN equipped sensor 61, object detection from images captured by the DNN equipped sensor 61, a photometric process according to types of detected objects, exposure control based on photometric results, relearning of an inference model, adjustment of camera control parameters associated with exposure control, and others.

The exposure control system 51 includes the DNN equipped sensor 61, a cloud 62, and a PC (personal computer) 63.

The DNN equipped sensor 61, the cloud 62, and the PC 63 are connected to each other to establish mutual communication via a communication network 64 such as the Internet and a local network. However, the DNN equipped sensor 61 may directly be connected to a network via the communication I/F 34, or connected to a network via the communication I/F 34 by using a communication function of an edge device equipped with the DNN equipped sensor 61.

### (DNN Equipped Sensor 61)

The DNN equipped sensor 61 is, for example, mounted on any device such as a camera, a smartphone, a tablet, and a laptop PC (personal computer). The DNN equipped sensor 61 includes the imaging device 2 depicted in FIG. 2 and equipped with a calculation function based on an inference model (DNN). For example, the DNN equipped sensor 61 executes calculation of the inference model by using the DSP 32 of the imaging device 2.

The DNN equipped sensor 61 acquires data regarding the inference model (DNN) and camera control parameters used for exposure control or the like, both from the cloud 62 during a start sequence at a start. The data regarding the inference model indicates such parameters as a weight and a bias at each node constituting the DNN. The data regarding the inference model will hereinafter also simply be referred to as an inference model.

The DNN equipped sensor 61 achieves object detection from images captured by the imaging unit 21 of the imaging device 2, by performing a calculation process using the inference model received from the cloud 62. Types (classes) and regions of objects contained in the images are detected as a result of object detection using the inference model. The DNN equipped sensor 61 performs photometry and exposure control in reference to the types and the regions of the detected objects.

The DNN equipped sensor 61 supplies learning data used for relearning of the inference model and relearning data used for adjustment of camera control parameters to the cloud 62, in a case where it is necessary.

### (Cloud 62)

One or multiple types of learned inference models learned beforehand are stored in the cloud 62. The inference model executes object detection from an input image, and outputs types (classes) of objects contained in the input image, detection regions (bounding boxes) of the respective objects, and the like. Note that each of the detection regions of the objects has a rectangular shape, for example. Coordinates of upper left and lower right vertexes of each of the detection regions, for example, are output from the inference model as information indicating the regions of the objects.

Camera control parameters used for achieving appropriate exposure control in correspondence with each class of the objects are stored in the cloud 62 for each class of the objects detectable by the respective stored inference models. The exposure control refers to control associated with a shutter speed, an aperture value, ISO sensitivity (gain), and a photometric area. The appropriate exposure control in correspondence with each class of the objects refers to exposure control which achieves appropriate (accurate) detection of objects of respective classes contained in an image by the inference model.

The cloud 62 supplies an inference model of a type designated by a user through the personal computer 63 and camera control parameters to the DNN equipped sensor 61. The DNN equipped sensor 61 performs object detection and exposure control by using the inference model and the camera control parameters received from the cloud 62.

The cloud 62 achieves relearning of the learning model and adjustment of the camera control parameters by using relearning data received from the DNN equipped sensor 61.

### (PC 63)

The PC 63 is a device operated by the user for designating a type of a learning model to be supplied from the cloud 62 to the DNN equipped sensor 61 and a class of an object to be detected by the DNN equipped sensor 61, for example. The PC 63 may be replaced with a device other than the PC 63 as long as this device is allowed to access the cloud 62. The device as an alternative to the PC 63 may, for example, be either an edge device on which the DNN equipped sensor 61 is mounted, or a portable terminal, such as a smartphone, other than an edge device on which the DNN equipped sensor 61 is mounted.

### (Details of DNN Equipped Sensor 61)

The DNN equipped sensor 61 includes an inference model/parameter setting unit 81, an inference model operation unit 82, an inference execution unit 83, an inference result creation unit 84, an inference result analysis unit 85, a setting value determination unit 86, a setting value reflection unit 87, and a relearning data transmission determination unit 88. Each of the model/parameter setting unit 81, the inference result creation unit 84, the inference result analysis unit 85, the setting value determination unit 86, the setting value reflection unit 87, and the relearning data transmission determination unit 88 is mainly a block representing a process to be performed by the CPU 31 of the imaging device 2 in FIG. 1. Each of the inference model operation unit 82 and the inference execution unit 83 is mainly a block representing a process to be performed by the DSP 32 of the imaging device 2 in FIG. 1.

### (Inference Model/Parameter Setting Unit 81)

The inference model/parameter setting unit 81 (CPU 31) sets an inference model and camera control parameters to be supplied from the cloud 62 for the DNN equipped sensor 61 during the start sequence at the start of the DNN equipped sensor 61. The inference model/parameter setting unit 81 acquires data regarding the inference model and the camera control parameters received from the cloud 62 and the communication I/F 34, and saves the acquired data and parameters in the memory 33.

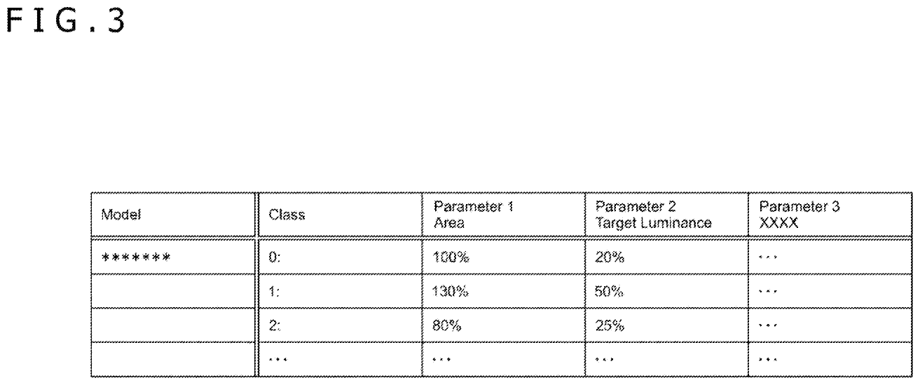

FIG. 3 is a diagram illustrating some of camera control parameters.

In FIG. 3, a column “Model” in the first row from the left represents a type (kind) of an inference model. A column “Class” in the second row from the left represents a type (class) of an object corresponding to a detection target of the inference model in the first row. A name of an object corresponding to a detection target is allocated to each of class numbers 0, 1, 2, and others. For example, a human, a car, and a dog are designated as names of objects for class 1, class 2, and class 3, respectively.

The inference model outputs the same number of probability maps as the number of the classes. A region of each of the probability maps corresponding to the respective classes is divided into grid shapes to form a structure where small regions (divisional regions) each being divided and having a grid shape are two-dimensionally arranged. Each of the divisional regions is associated with a position on an input image. The inference model outputs a probability (score) as an output value associated with the corresponding one of the respective divisional regions of the probability maps for the respective classes. Each of the scores of the respective divisional regions of the respective probability maps represents a probability of presence of a center of the object of the class associated with the corresponding one of the respective probability maps. Accordingly, a score (high score) higher than a predetermined value in the scores of the respective divisional regions of the probability maps of the respective classes indicates that there has been detected an object of the class associated with the probability map to which the divisional region exhibiting this high score belongs. The position of the divisional region exhibiting the high score represents that the center of the detected object exists on the input image at a position associated with this divisional region.

The center of the object refers to a center of a detection region (bounding box) having a rectangular shape and surrounding the object. The inference model outputs information associated with a range of the detection region, such as sizes of longitudinal and lateral widths of the detection region and coordinates of diagonal points of the detection region, in addition to the probability map indicating the class, the center, and the probability of the detected object. Note that the inference model may include a case of outputting coordinates of a more accurate center of the detection region than the center of the object (detection region) recognizable from the probability map and longitudinal and lateral widths of the detection region.

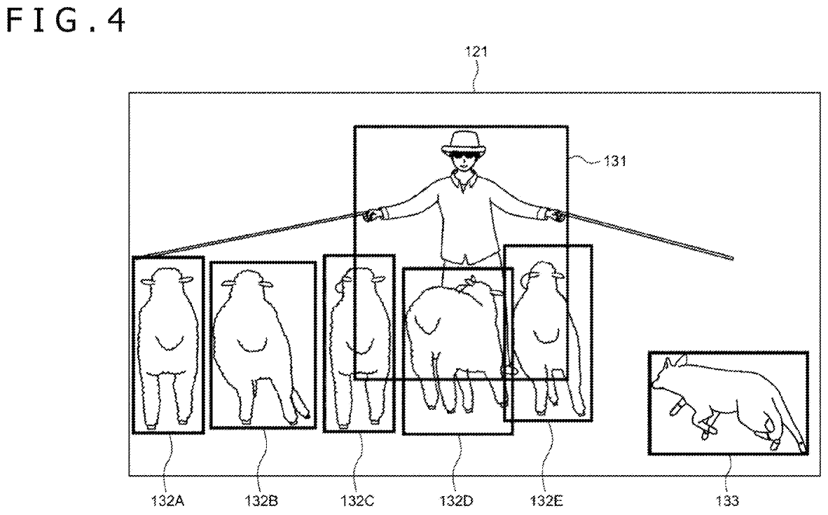

FIG. 4 is a diagram depicting an example of a result of object detection by the inference model.

FIG. 4 depicts a case where a human, sheep, and a dog contained in an input image 121 are detected as objects of classes corresponding to detection targets in a case where the input image 121 is input to the inference model. A detection region 131 represents a region where the human has been detected. Each of detection regions 132A to 132E represents a region where a sheep has been detected. A detection region 133 represents a region where the dog has been detected.

As described above, the inference model detects an object belonging to any one of classes of objects corresponding to detection targets from an input image, and outputs the class and a probability of the detected object (a probability that the detected object belongs to the detected class) and information indicating a detection region of the detected object (information specifying a range).

It is assumed in the following description that the inference model outputs a class of an object detected from an input image and a probability (score) that the detected object belongs to the detected class, and also outputs coordinates of a detection region (e.g., coordinates of upper left and lower right vertexes of the detection region) as information indicating the detection region of the object. Actual outputs from the inference model are not limited to outputs in a specific mode.

In FIG. 3, a column “Parameter 1 Area” in the third row from the left represents a size magnification of a photometric area (a magnification ratio of the photometric area) to a detection region of an object. The magnification ratio of the photometric area is set for each of classes of detected objects.

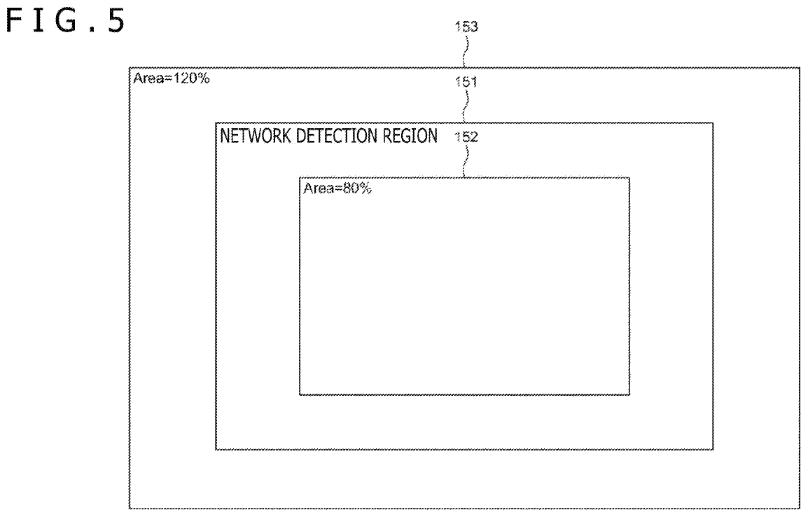

FIG. 5 is a diagram depicting an example of a relation between a detection region of an object and a photometric area.

In FIG. 5, a detection region 151 (network detection region) represents a detection region of an object detected by an inference model. Meanwhile, a photometric area 152 represents a photometric area defined in a case where a magnification ratio of a photometric area in FIG. 3 is 120%. The photometric area 152 has a longitudinal width and a lateral width expanded by 120% of (1.2 times) a longitudinal width and a lateral width of the detection region 151, with an aspect ratio kept equal to an aspect ratio of the detection region 151.

A photometric area 153 represents a photometric area defined in a case where the magnification ratio of the photometric area in FIG. 3 is 80%. The photometric area 153 has a longitudinal width and a lateral width contracted by 80% of (0.8 times) the longitudinal width and the lateral width of the detection region 151, with an aspect ratio kept equal to the aspect ratio of the detection region 151.

A column “Parameter 2 Target Luminance” in the fourth row from the left in FIG. 3 represents an appropriate exposure amount (goal value of exposure amount: goal exposure amount). The goal exposure amount is set for each class of detected objects. The goal exposure amount is represented as a proportion to a maximum value of an average luminance value of pixels contained in a photometric area of a target image (average luminance of the photometric area). Note that the target image refers to an image corresponding to a target of exposure control.

For example, in a case where a luminance value of each pixel is represented by 8 bits (0 to 255), a maximum value of the average luminance in the photometric area is 255. In this case, if the goal exposure amount is n×100(%), it is indicated that exposure is so controlled as to produce average luminance of 255×n in the photometric area.

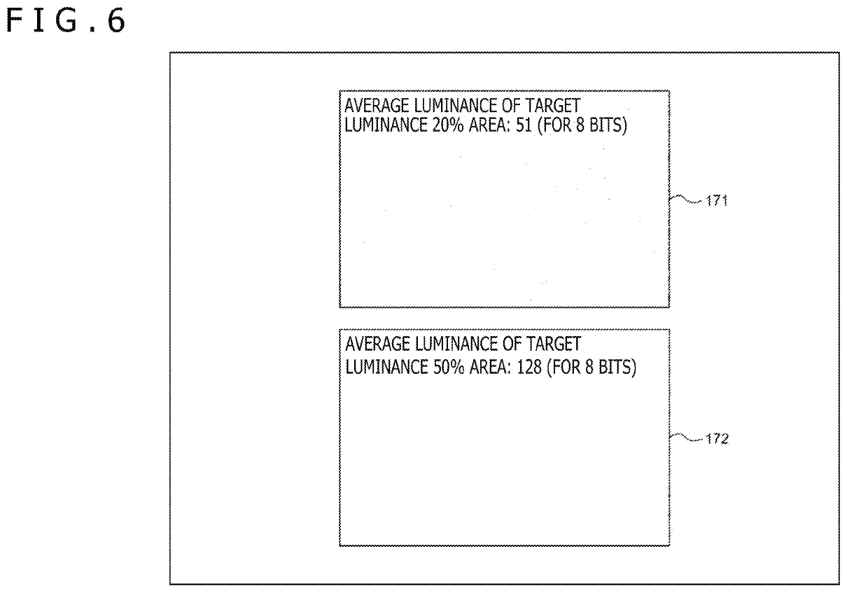

FIG. 6 is a diagram depicting an example of a relation between a goal exposure amount and brightness of a target image in a case of exposure control according to the goal exposure amount.

In FIG. 6, a target image 171 exhibits brightness of an image (an image within the photometric area) in a case of exposure control with a goal exposure amount of 20%. When the goal exposure amount is 20% in a case where each pixel value of the target image is represented by 8 bits (0 to 255), exposure is controlled such that the photometric area of the target image 171 has average luminance of 51.

A target image 172 exhibits brightness of an image (an image within the photometric area) in a case of exposure control with a goal exposure amount of 50%. When the goal exposure amount is 50% in a case where each pixel value of the target image is represented by 8 bits (0 to 255), exposure is controlled such that the photometric area of the target image 172 has average luminance of 128. In a case where the target image 171 and the target image 172 are compared, the target image 172 for which a larger goal exposure amount has been set has a brighter image within the photometric area.

The inference model/parameter setting unit 81 in FIG. 2 acquires, from an inference model/parameter saving unit 101 of the cloud 62, information indicating a magnification ratio of a photometric area and a goal exposure amount for each class in the inference model used by the DNN equipped sensor 61 in FIG. 1, as camera control parameters, and saves the acquired information in the memory 33 in FIG. 1.

Note that the camera control parameters are not limited to the magnification ratio of the photometric area and the goal exposure amount, and may include only either one of these, or may be parameters other than the magnification ratio of the photometric area and the goal exposure amount. In addition, the camera control parameters are not limited to parameters associated with exposure control. For example, the camera control parameters are only required to include at least either a parameter associated with imaging by the imaging unit 21 in FIG. 1 or a parameter associated with signal processing for images captured by the imaging unit 21 (input images input to the inference model).

For example, there may be cases where the camera control parameters include any one of a magnification ratio of a photometric area, a goal exposure amount, a shutter time, analog gain, digital gain, a linear matrix coefficient (parameter associated with color adjustment), a gamma parameter, an NR (noise reduction) setting, and others. In a case where these parameters are designated as the camera control parameters, values of the parameters are set to such values that improve detection accuracy of object detection by the inference model for each class of objects corresponding to detection targets.

### (Inference Model Operation Unit 82)

The inference model operation unit 82 (DSP 32) starts operation (calculation process) of an inference model saved in the memory 33 by the inference model/parameter setting unit 81 during the start sequence. In response to the start of the operation of the inference model, object detection starts for an image captured by the imaging unit 21.

### (Inference Execution Unit 83)

The inference execution unit 83 (DSP 32) imports an image captured by the imaging unit 21 in FIG. 1 from the imaging block 20 to the signal processing block 30, and designates the imported image as an input image input to the inference model, in a regular sequence after the start sequence. The inference execution unit 83 performs a process for object detection from this input image by the inference model saved in the memory 33, and supplies output (inference result) obtained by the inference model to the inference result creation unit 84. As described above, the inference result to be obtained by the inference model includes a class and a probability of an object detected by the inference model and coordinates of a detection region of this object.

The inference execution unit 83 supplies the input image (inference image) input to the inference model and camera control parameters to the relearning data transmission determination unit 88. The camera control parameters include a magnification ratio of a photometric area (photometric area range), a goal exposure amount, a color adjustment value, and others set for the imaging unit 21 in FIG. 1 when the input image input to the inference execution unit 83 is captured.

### (Inference Result Creation Unit 84)

The inference result creation unit 84 (CPU 31) creates inference result data in reference to an inference result received from the inference execution unit 83, during the regular sequence.

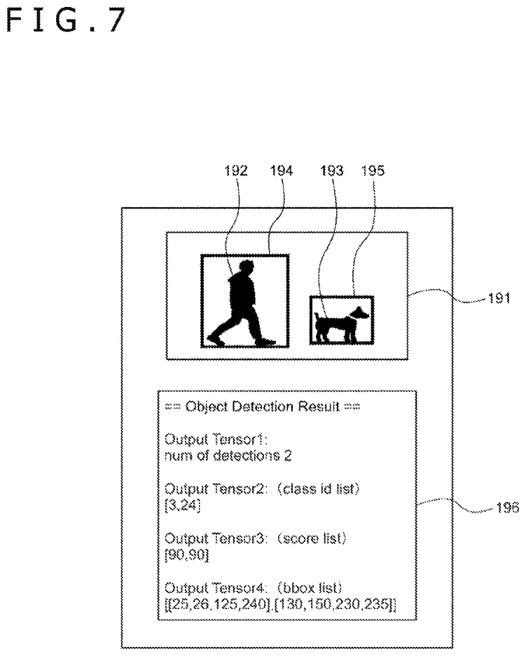

FIG. 7 is a diagram depicting an example of inference result data. In FIG. 7, an input image 191 represents an example of an image input to the inference model by the inference execution unit 83. The input image 191 contains a human 192 and a dog 193 corresponding to detection targets of the inference model. As an inference result obtained by the inference model, it is assumed that a detection region 194 has been obtained for the human 192 and that a detection region 195 has been obtained for the dog 193.

Inference result data 196 is created by the inference result creation unit 84 in reference to an inference result obtained by the inference model for the input image 191.

The inference result data 196 contains the number of detected objects, classes of the detected objects, probabilities (scores) that the detected objects belong to the corresponding detected classes, and coordinates of detection regions (bounding boxes).

Specifically, as indicated by the inference result data 196, the number of the detected objects is 2, the class of the detected human 192 is class 3, and the class of the detected dog 193 is class 24. As indicated, the probability (score) that the detected human 192 is an object of class 3 is 90, while the probability (score) that the detected dog 193 is an object of class 24 is 90. As indicated, the coordinates of the detection region of the human 192 are (25, 26, 125, 240), while the coordinates of the detection region of the dog 193 are (130, 150, 230, 235). The coordinates of each of the detection regions represent x and y coordinates of an upper left vertex and x and y coordinates of a lower right vertex of the corresponding detection region on the image.

The inference result creation unit 84 supplies created inference result data to the inference result analysis unit 85.

### (Inference Result Analysis Unit 85)

The inference result analysis unit 85 analyzes inference result data received from the inference result creation unit 84, during the regular sequence. At the time of analysis, the inference result analysis unit 85 uses a subject number supplied from an object setting unit 102 of the cloud 62. The subject number represents a class (class number) of an object corresponding to a main detection target among classes of objects corresponding to detection targets of the inference model. The subject number is designated by a user. The subject number may be designated by the user through his or her check of objects contained in an image captured by the DNN equipped sensor, or a class of an object determined by the user or the like beforehand may be designated as the subject number.

The inference result analysis unit 85 determines, as a main detection object, an object corresponding to the subject number in objects contained in the inference result data received from the inference result creation unit 84. In a case where there exist multiple objects corresponding to the subject number, an object exhibiting the maximum probability (score) is determined as the main detection object. The inference result analysis unit 85 extracts only data regarding the main detection object from the inference result data. The extracted data will be referred to as main detection object data.

In addition, in a case where no object corresponding to the subject number is detected, the inference result analysis unit 85 may determine, as the main detection object, an object exhibiting the highest probability (score) or an object having the largest detection region among the objects detected by the inference model (inference execution unit 83), for example. The user may designate multiple classes as the subject numbers with priorities set for the respective classes, and the inference result analysis unit 85 may determine an object having the subject number with the highest priority among the objects detected by the inference model (inference execution unit 83), as the main detection object. There may be a case where the exposure control system 51 does have the configuration for designating the subject number. In this case, an object exhibiting the highest probability (score) or an object having the largest detection region among the objects detected by the inference model (inference execution unit 83) may be determined as the main detection object.

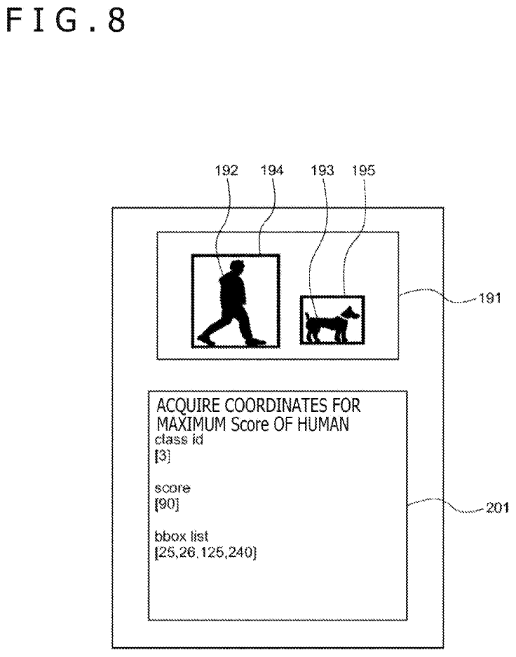

FIG. 8 is a diagram depicting an example of main detection object data extracted from the inference result data in FIG. 7.

The input image 191 in FIG. 8 is identical to the input image 191 in FIG. 7. Identical parts are given identical reference signs, and not repeatedly described.

Main detection object data 201 in FIG. 8 is created by the inference result analysis unit 85 in reference to inference result data created for the input image 191.

The main detection object data 201 contains a class (subject number) of a main detection object corresponding to a subject number among the objects contained in the inference result data, a probability (score) that this main detection object is an object belonging to the class, and coordinates of a detection region (bounding box) of the main detection object.

Specifically, the main detection object data 201 represents a case where the main detection object is the human 192 under the designated subject number of 3 (class 3) indicating a human. In the main detection object data 201, the human 192 corresponding to the main detection object belongs to class 3 corresponding to the subject number. It is indicated that the probability (score) that the human 192 which is the main detection object is an object belonging to class 3 is 90. It is indicated that coordinates of the detection region of the human 192 which is the main detection object are (25, 26, 125, 240).

The inference result analysis unit 85 supplies the created main detection object data to the relearning data transmission determination unit 88.

The inference result analysis unit 85 supplies the subject number and the coordinates of the detection region of the main detection object to the setting value determination unit 86.

### (Setting Value Determination Unit 86)

During the regular sequence, the setting value determination unit 86 (CPU 31) determines a setting value associated with photometric position control (referred to as photometric position control value) and a setting value associated with exposure goal control (referred to as exposure goal setting value), in reference to camera control parameters (a magnification ratio of a photometric area and a goal exposure amount) saved in the memory 33 and a subject number and coordinates of a detection region of a main detection object supplied from the inference result analysis unit 85.

For example, the photometric position control value determined by the setting value determination unit 86 represents coordinate values for specifying a range of a photometric area where an exposure amount is detected (coordinates of upper left and lower right vertexes of the photometric area). The setting value determination unit 86 acquires a magnification ratio of a photometric area corresponding to a subject number (see the column in the third row from the left in FIG. 3) from camera control parameters saved in the memory 33. The setting value determination unit 86 determines the photometric position control value for specifying the range of the photometric area, in reference to the coordinates that indicate the detection region of the main detection object and that have been received from the inference result analysis unit 85 and the magnification ratio of the photometric area. The setting value determination unit 86 supplies the determined photometric position control value to the setting value reflection unit 87.

The exposure goal control value is a setting value indicating an appropriate exposure amount (goal exposure amount) of a photometric area. The setting value determination unit 86 acquires a goal exposure amount corresponding to a subject number (see a column in the fourth row from the left in FIG. 3) from camera control parameters saved in the memory 33. The setting value determination unit 86 determines the acquired goal exposure amount corresponding to the subject number, as an exposure goal control value.

The setting value determination unit 86 supplies the determined photometric position control value and the determined exposure goal control value to the setting value reflection unit 87.

### (Setting Value Reflection Unit 87)

During the regular sequence, the setting value reflection unit 87 (CPU 31) reflects a photometric position control value and an exposure goal control value determined by the setting value determination unit 86. Specifically, the setting value reflection unit 87 sets a photometric area in a range indicated by the photometric position control value for an input image input to the inference execution unit 83.

The setting value reflection unit 87 calculates average luminance (exposure amount) of the photometric area set for the input image. The setting value reflection unit 87 sets a goal value of at least any one of a shutter speed (exposure time), an aperture value, and ISO sensitivity (analog gain or digital gain) such that the calculated exposure amount of the photometric area reaches a goal exposure amount, in reference to the calculated exposure amount of the photometric area and the goal exposure amount.

For example, in a case where the aperture value and the ISO sensitivity included in the items of the shutter speed (exposure time), the aperture value, and the ISO sensitivity are fixed, the setting value reflection unit 87 sets goal values by changing only a current value of the shutter speed. In a case where the goal exposure amount is twice larger than the exposure amount of the photometric area in this case, the goal value of the shutter speed is decreased by one step from the current value (the goal value of the exposure time is doubled). In a case where the ISO sensitivity included in the items of the shutter speed (exposure time), the aperture value, and the ISO sensitivity is fixed, the setting value reflection unit 87 sets goal values obtained by changing current values of the shutter speed and the aperture value.

Note that various methods are known as an exposure control method, such as shutter speed prioritized AE (Automatic Exposure), aperture prioritized AE, and program AE. Any methods are available for this purpose. It is assumed hereinafter that a goal value is also set for each value which is to be fixed in the values of the shutter speed (exposure time), the aperture value, and the ISO sensitivity regardless of which of these items is to be controlled.

The setting value reflection unit 87 stores the set goal values in the register group 27 in FIG. 1. In reference to the goal values thus stored, the shutter speed, the aperture value, and the ISO sensitivity are controlled by the imaging processing unit 22 or an unillustrated optical drive system such that these values reach the goal values stored in the register group 27.

In such a manner, the setting value reflection unit 87 controls the shutter speed, the aperture value, and the ISO sensitivity such that the exposure amount of the photometric area in the input image reaches the goal exposure amount (exposure goal control). Under this control, brightness of an image of a main detection object in an image captured by the imaging unit 21 is adjusted to brightness appropriate for detection of the main detection object achieved by the inference model.

After completion of the exposure goal control by the setting value reflection unit 87, the inference execution unit 83 imports a new image captured by the imaging unit 21, to perform object detection from the imported image designated as an input image input to the inference model.

During the regular sequence, the foregoing processing performed by the inference execution unit 83, the inference result creation unit 84, the inference result analysis unit 85, the setting value determination unit 86, and the setting value reflection unit 87 is repeated in a predetermined cycle in a case where imaging by the imaging unit 21 is continuously performed (e.g., moving images are captured), for example.

### (Relearning Data Transmission Determination Unit 88)

The relearning data transmission determination unit 88 (CPU 31) detects, from multiple pieces of main detection object data supplied from the inference result analysis unit 85 during an elapse of a predetermined period of time, main detection object data exhibiting a probability (score) which deviates from an average of probabilities (scores) of these pieces of main detection object data. For example, in a case where the probability is lower than the average by a predetermined threshold or more, main detection object data exhibiting this probability is detected. The relearning data transmission determination unit 88 supplies the detected main detection object data, an input image (inference image) input to the inference model (inference execution unit 83) when the main detection object data is obtained, and camera control parameters obtained when the input image is captured, to a relearning unit 103 of the cloud 62 as relearning data.

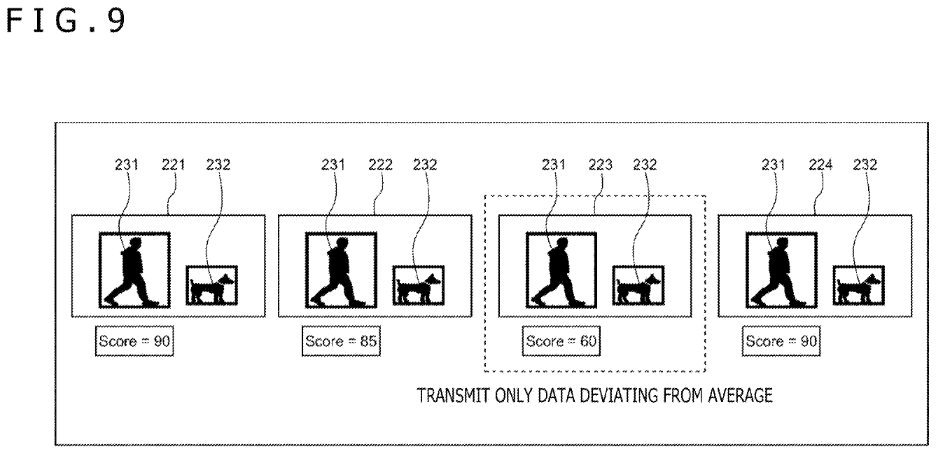

FIG. 9 is a diagram explaining a process performed by the relearning data transmission determination unit 88.

In FIG. 9, each of input images 221 to 224 represents an input image input to an inference model for main detection object data supplied from the inference result analysis unit 85 to the relearning data transmission determination unit 88, during an elapse of a predetermined period of time determined beforehand. Each of the input images 221 to 224 contains a human 231 and a dog 232 similarly to the input image 191 in FIG. 8. It is assumed that class 3 indicating a human is designated as a subject number and that main detection object data concerning the human 231 as the main detection object is supplied from the inference result analysis unit 85 to the relearning data transmission determination unit 88. In this case, it is assumed that probabilities (scores) exhibited by the respective piece of main detection object data for the input images 221 to 224 are 90, 85, 60, and 90, respectively.

The relearning data transmission determination unit 88 determines (detects) that the probability of the main detection object data exhibiting the probability of 60 (the main detection object data for the input image 223) deviates from an average (81.25). The relearning data transmission determination unit 88 supplies (transmits) the input image 223, the main detection object data obtained for the input image 223, and camera control parameters obtained when the input image 223 is captured, to the relearning unit 103 of the cloud 62 as relearning data. However, determination regarding the relearning data is not required to be made in the foregoing manner, and may be made in the following manner.

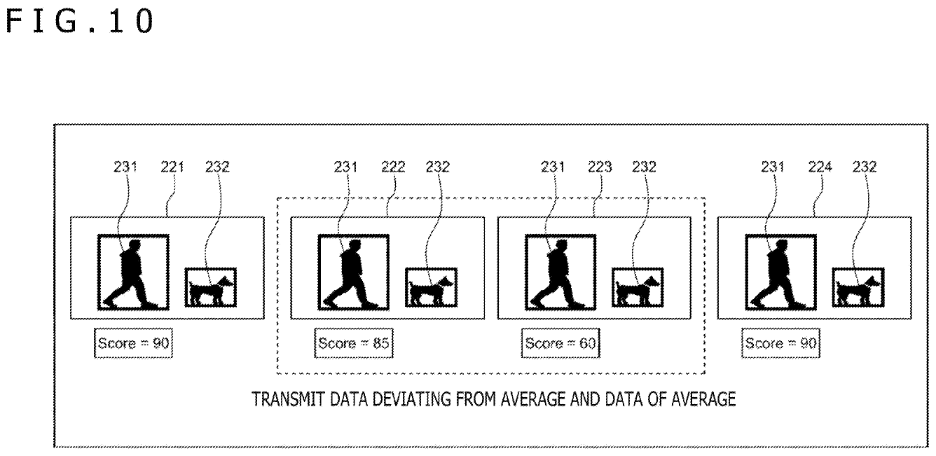

FIG. 10 is a diagram explaining another mode of the process performed by the relearning data transmission determination unit 88. Note that parts depicted in the figure and identical to corresponding parts in FIG. 9 are given identical reference signs, and not repeatedly explained.

The relearning data transmission determination unit 88 detects main detection object data which exhibits a probability deviating from an average and main detection object data which exhibits a probability closest to the average. The relearning data transmission determination unit 88 in FIG. 10 determines (detects) that the probability of the main detection object data exhibiting the probability of 60 (the main detection object data for the input image 223) deviates from the average (81.25). The relearning data transmission determination unit 88 determines (detects) that the probability of the main detection object data exhibiting the probability of 85 (the main detection object data for the input image 222) is closest to the average (81.25). The relearning data transmission determination unit 88 supplies (transmits) the input images 222 and 223, the main detection object data obtained for the input images 222 and 223, and camera control parameters obtained when the input images 222 and 223 are captured, to the relearning unit 103 of the cloud 62 as relearning data.

Note that the camera control parameters supplied to the cloud 62 as relearning data may include a shutter time, analog gain, digital gain, a linear matrix coefficient, a gamma parameter, an NR (noise reduction) setting, or the like as well as a magnification ratio of a photometric area and a goal exposure amount.

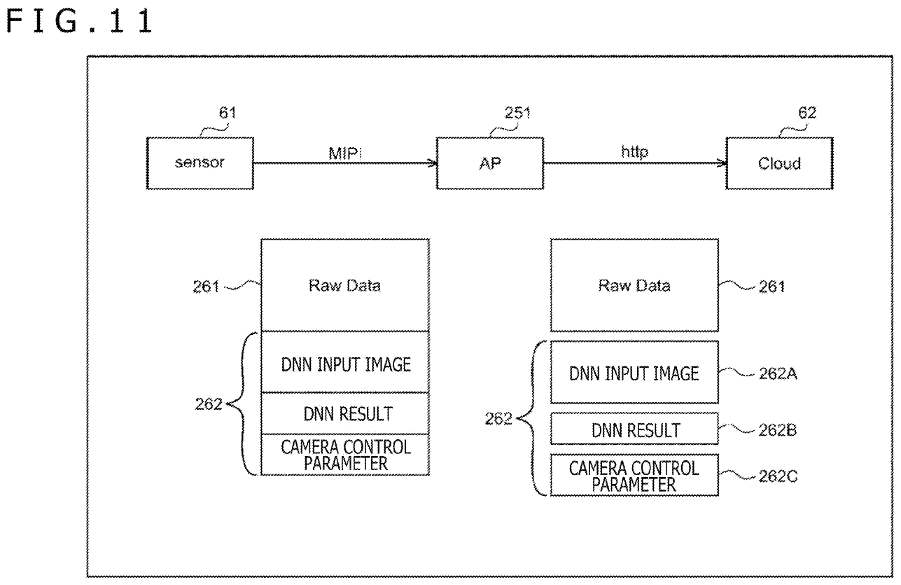

FIG. 11 is a diagram depicting a state of transmission of relearning data from the DNN equipped sensor 61 to the cloud 62.

FIG. 11 depicts a case of transmission of an image captured by the DNN equipped sensor 61 to the cloud 62. An image (Raw Data) 261 captured by the DNN equipped sensor 61 and relearning data 262 transmitted from the relearning data transmission determination unit 88 to the cloud 62 are transmitted as one file data from the DNN equipped sensor 61 to an AP (application processor) 251 by MIPI, for example. The AP 251 is included in an edge device on which the DNN equipped sensor 61 is mounted. The image 261 and the relearning data 262 are transmitted by the output control unit 23 in FIG. 2 as one file from the output I/F 24 to the AP 251.

In the AP 251, the image 261 and the relearning data 262 received from the DNN equipped sensor 61 are divided into data in separate files. The relearning data 262 contains an input image 262A (DNN input image) input to the inference model, main detection object data 262B (DNN result) received from the inference result analysis unit 85, and camera control parameters 262C. These are also divided into data in separate files.

The image 261, the input image 262A, the main detection object data 262B, and the camera control parameters 262C each divided by the AP 251 are transmitted from the AP 251 to the cloud 62 by HTTP (Hypertext Transfer Protocol). Note that the image 261 captured by the DNN equipped sensor 61 is not transmitted to the cloud 62 in some cases. The relearning data 262 may be transmitted as data of one file from the AP 251 to the cloud 62, or the image 261 and the relearning data 262 may be transmitted as data of one file from the AP 251 to the cloud 62.

### (Details of Cloud 62)

The cloud 62 includes the inference model/parameter saving unit 101, the object setting unit 102, and the relearning unit 103.

### (Inference Model/Parameter Saving Unit 101)

As described with reference to FIG. 3, the inference model/parameter saving unit 101 saves one or multiple types of inference models and camera control parameters corresponding to the respective inference models. During the start sequence performed by the DNN equipped sensor 61, the inference model/parameter saving unit 101 supplies, to the inference model/parameter setting unit 81 of the DNN equipped sensor 61, data regarding the inference model of the type designated by an operation input from the user to the PC 63 and camera control parameters corresponding to this inference model.

### (Object Setting Unit 102)

The object setting unit 102 supplies, to the inference result analysis unit 85 of the DNN equipped sensor 61, a class (subject number) of an object designated by the operation input from the user to the PC 63. The subject number designated by the user represents a class of a main detection object corresponding to a main detection target among classes of objects corresponding to detection targets of the inference model. The main detection object is a target at the time of exposure control or the like performed to achieve appropriate object detection by the inference model.

### (Relearning Unit 103)

The relearning unit 103 performs relearning of an inference model saved in the inference model/parameter saving unit 101 by using relearning data supplied from the relearning data transmission determination unit 88 of the DNN equipped sensor 61 (processing as a learning unit) or adjustment of camera control parameters (processing as an adjustment unit), and updates the inference model saved in the inference model/parameter saving unit 101 (update of weight, bias, or the like) or the camera control parameters according to the results of the processing.

For performing the relearning of the inference model and the adjustment of the camera control parameters, the relearning unit 103 can select a first process which only makes the adjustment of the camera control parameters and a second process which carries out the relearning of the inference model.

In the first process, the relearning unit 103 adjusts the camera control parameters in reference to relearning data such that a probability (score) that a main detection object detected by the inference model belongs to a class of a subject number rises. In a specific example, the relearning unit 103 forms an input image corresponding to a case of a change of the respective camera control parameters in reference to an input image contained in the relearning data and input to the inference model. For example, the relearning unit 103 changes a current value of a magnification ratio of a photometric area corresponding to a main detection object in the camera control parameters. In this case, the input image is formed by changing entire brightness (luminance) of the image such that an exposure amount (average luminance) of the changed photometric area reaches a goal exposure amount. The relearning unit 103 performs object detection from the formed input image by the inference model, and calculates a probability (score) that the main detection object belongs to the class of the subject number. In such a manner, the relearning unit 103 forms the input image by changing the magnification ratio of the photometric area to various values, and inputs the formed input image to the inference model to calculate a probability (score). The relearning unit 103 updates the camera control parameters in the inference model/parameter saving unit 101 by the magnification ratio of the photometric area obtained when the probability rises at least higher than the probability prior to the change (or when the probability is maximized).

Similarly, the relearning unit 103 changes a current value of a goal exposure amount that is included in the camera control parameters and that corresponds to the main detection object. In this case, the input image is formed by changing entire brightness of the image such that an exposure amount of the photometric area reaches the goal exposure amount. The relearning unit 103 performs object detection from the formed input image by the inference model, and calculates a probability (score) that the main detection object belongs to the class of the subject number. In such a manner, the relearning unit 103 forms the input image by changing the goal exposure amount to various values, and inputs the formed input image to the inference model to calculate a probability (score). The relearning unit 103 updates the camera control parameters in the inference model/parameter saving unit 101 by the goal exposure amount obtained when the probability rises at least higher than the probability prior to the change (or when the probability is the maximum value). However, the method for adjusting the camera control parameters is not limited to the foregoing methods presented by way of example.

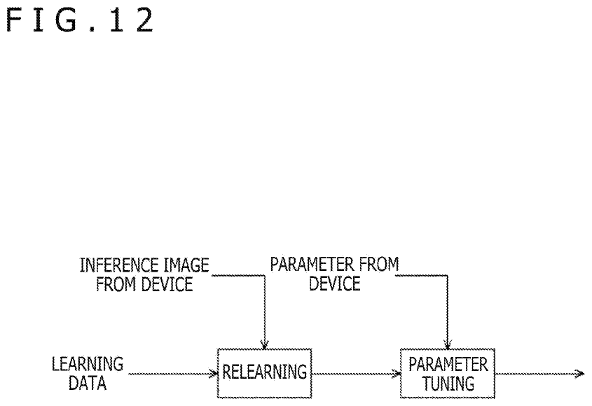

FIG. 12 is a diagram explaining the second process performed by the relearning unit 103. In the second process, the relearning unit 103 generates a correct answer label (correct answer output) for an input image (inference image) contained in relearning data, in reference to main detection object data contained in the relearning data, and designates a pair of these input image and correct answer label as learning data. Note that the input image (inference image) may be either an input image obtained when a probability (score) exhibited by the main detection object data deviates from an average as explained with reference to FIG. 9 or an input image obtained when a probability (score) exhibited by the main detection object data is close to an average as explained with reference to FIG. 10.

The relearning unit 103 learns an inference model by using generated learning data and updates parameters of the inference model as depicted in FIG. 12. After update of the parameters of the inference model, the relearning unit 103 inputs an input image (inference image) contained in relearning data to the inference model, and performs object detection. In a case where a probability (score) that a detected main detection object belongs to a class of a subject number consequently rises (in a case where a better result is obtained), the relearning unit 103 updates the inference model in the inference model/parameter saving unit 101 to an inference model corresponding to the updated parameters. In a case where the probability (score) that the detected main detection object belongs to the class of the subject number lowers (in a case where a worse result is obtained), the relearning unit 103 does not update the inference model in the inference model/parameter saving unit 101.

In a case where the inference model in the inference model/parameter saving unit 101 is updated, the relearning unit 103 adjusts camera control parameters in the manner depicted in FIG. 12 as necessary. This adjustment of the camera control parameters is achieved in a manner similar to the manner of the first process. Accordingly, this adjustment is not repeatedly explained.

Note that the cloud 62 may either only pick up relearning data and transmit the picked-up relearning data to the PC 63 to inform the user of the relearning data, or may perform relearning of the inference model without informing the user.

According to the exposure control system 51 described above, the DNN equipped sensor 61 performs camera control suited for detection of an object belonging to a corresponding class, according to each class (type) of objects detected by an inference model. Accordingly, accuracy of object detection (recognition) by the inference model improves.

An image input to the inference model is optimized by camera control parameters according to the class of the object detected by the inference model. This optimization of the image eliminates the necessity of learning the inference model with use of an inappropriate image, and hence reduces learning data. For example, luminance (exposure amount) of the image input to the inference model is optimized by camera control parameters. This optimization of luminance lowers the necessity of using an image having different luminance as learning data, and hence reduces learning data.

Relearning data transmitted to the cloud 62 is only the relearning data necessary for relearning. Accordingly, reduction of a communication band and processing performed in an edge device can be achieved.

A difference between detection accuracy during learning of the inference model and detection accuracy during inference can be compensated only by adjustment of the camera control parameters. Accordingly, the necessity of relearning the inference model can be eliminated.

Even when the learning data of the inference model is biased, this bias is absorbable by adjustment of the camera control parameters. Accordingly, the necessity of relearning of the inference model can be eliminated.

Note that PTL 1 (Japanese Patent Laid-open No. 2012-63385) does not disclose that camera control parameters are varied according to classes (types) of objects as in the manner of the present technology.

### (Different Configuration Example 1 of Exposure Control System)

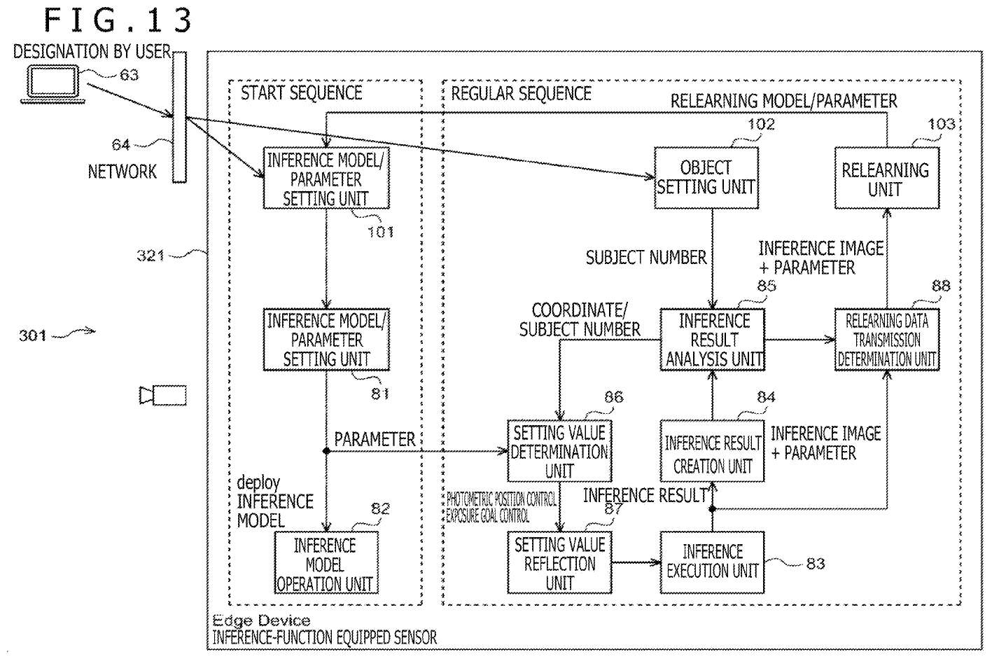

FIG. 13 is a block diagram depicting a different configuration example 1 of the exposure control system. Note that parts depicted in the figure and identical to corresponding parts of the exposure control system 51 in FIG. 2 are given identical reference signs, and are not repeatedly explained.

An exposure control system 301 in FIG. 13 includes the PC 63 and a DNN equipped sensor 321. The DNN equipped sensor 321 includes the inference model/parameter setting unit 81, the inference model operation unit 82, the inference execution unit 83, the inference result creation unit 84, the inference result analysis unit 85, the setting value determination unit 86, the setting value reflection unit 87, the relearning data transmission determination unit 88, the inference model/parameter saving unit 101, the object setting unit 102, and the relearning unit 103. Accordingly, the exposure control system 301 in FIG. 13 is similar to the exposure control system 51 in FIG. 2 in that the PC 63 and the DNN equipped sensor 321 are provided and that the inference model/parameter setting unit 81, the inference model operation unit 82, the inference execution unit 83, the inference result creation unit 84, the inference result analysis unit 85, the setting value determination unit 86, the setting value reflection unit 87, the relearning data transmission determination unit 88, the inference model/parameter saving unit 101, the object setting unit 102, and the relearning unit 103 are provided. However, the exposure control system 301 in FIG. 13 is different from the system in FIG. 2 in that no cloud is provided.

According to the exposure control system 301 in FIG. 13, the processing performed in the cloud 62 in the case of the exposure control system 51 in FIG. 2 is performed by the DNN equipped sensor 321. A part of the processing performed by the DNN equipped sensor 321 may be performed by an edge device on which the DNN equipped sensor 321 is mounted.

According to the exposure control system 301, relearning of an inference, adjustment of camera control parameters, and the like can be achieved by the DNN equipped sensor 321 or an edge device on which the DNN equipped sensor 321 is mounted.

According to the exposure control system 301, similarly to the exposure control system 51 in FIG. 2, the DNN equipped sensor 321 performs camera control suited for detection of an object belonging to a corresponding class, according to each class (type) of objects detected by an inference model. Accordingly, accuracy of object detection (recognition) by the inference model improves.

An image input to the inference model is optimized by camera control parameters according to the class of the object detected by the inference model. This optimization of the image eliminates the necessity of learning the inference model with use of an inappropriate image, and hence reduces learning data. For example, luminance (exposure amount) of the image input to the inference model is optimized by camera control parameters. This optimization of luminance lowers the necessity of using an image having different luminance as learning data, and hence reduces learning data.

A difference between detection accuracy during learning of the inference model and detection accuracy during inference can be compensated only by adjustment of the camera control parameters. Accordingly, the necessity of relearning the inference model can be eliminated.

Even when the learning data of the inference model is biased, this bias is absorbable by adjustment of the camera control parameters. Accordingly, the necessity of relearning the inference model can be eliminated.

### (Different Configuration Example 2 of Exposure Control System)

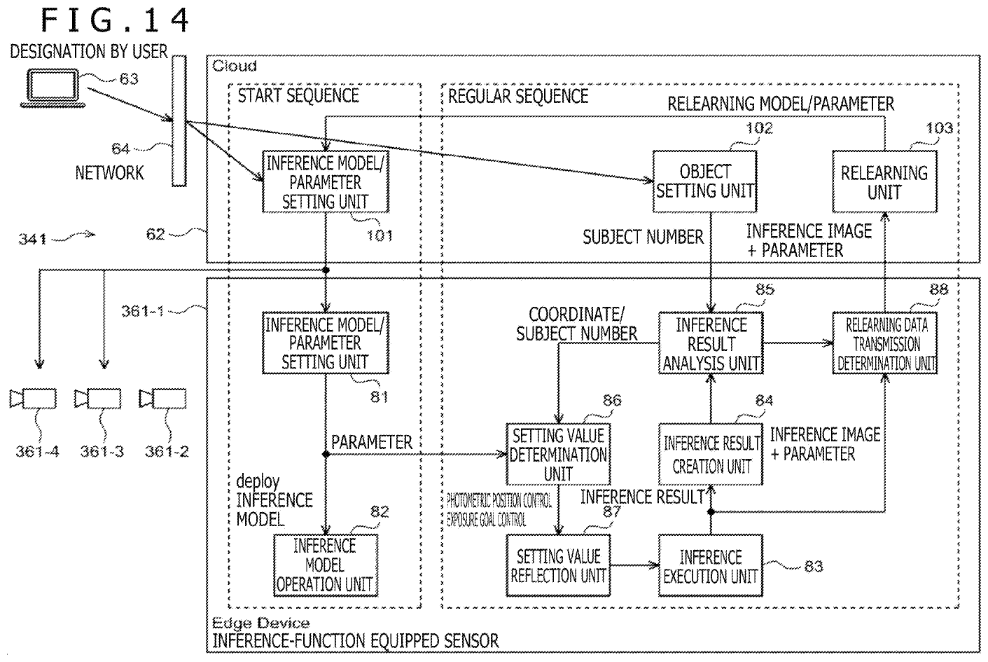

FIG. 14 is a block diagram depicting a different configuration example 2 of the exposure control system. Note that parts depicted in the figure and identical to corresponding parts of the exposure control system 51 in FIG. 2 are given identical reference signs, and are not repeatedly explained.

An exposure control system 341 in FIG. 14 includes the cloud 62, the PC 63, and DNN equipped sensors 361-1 to 361-4. The cloud 62 includes the inference model/parameter saving unit 101, the object setting unit 102, and the relearning unit 103. Each of the DNN equipped sensors 361-1 to 361-4 includes the inference model/parameter setting unit 81, the inference model operation unit 82, the inference execution unit 83, the inference result creation unit 84, the inference result analysis unit 85, the setting value determination unit 86, the setting value reflection unit 87, and the relearning data transmission determination unit 88.

Accordingly, the exposure control system 341 in FIG. 14 is similar to the exposure control system 51 in FIG. 2 in that the cloud 62, the PC 63, and the DNN equipped sensors 361-1 to 361-4 are provided, that the cloud 62 includes the inference model/parameter saving unit 101, the object setting unit 102, and the relearning unit 103, and that each of the DNN equipped sensors 361-1 to 361-4 includes the inference model/parameter setting unit 81, the inference model operation unit 82, the inference execution unit 83, the inference result creation unit 84, the inference result analysis unit 85, the setting value determination unit 86, the setting value reflection unit 87, and the relearning data transmission determination unit 88. However, the exposure control system 341 in FIG. 14 is different from that in the case of FIG. 2 in that multiple DNN equipped sensors 361-1 to 361-4 are provided.

Each of the DNN equipped sensors 361-1 to 361-4 has components similar to those of the DNN equipped sensor 361-1 depicted in FIG. 14. While the four DNN equipped sensors 361-1 to 361-4 are depicted in FIG. 14, the number of the DNN equipped sensors may be two or any number larger than two.

According to the exposure control system 341 in FIG. 14, a common inference model and common camera control parameters are available for the multiple DNN equipped sensors. The cloud 62 is allowed to acquire relearning data from the multiple DNN equipped sensors, and collectively achieve relearning of the inference model and adjustment of the camera control parameters used by the multiple DNN equipped sensors. The relearned inference model or the re-adjusted camera control parameters by relearning data of any one of the multiple DNN equipped sensors are reflected in other DNN equipped sensors. Accordingly, detection accuracy of object detection by the inference model efficiently improves.

According to the exposure control system 341, similarly to the exposure control system 51 in FIG. 2, each of the respective DNN equipped sensors performs camera control suited for detection of an object belonging to a corresponding class, according to each class (type) of objects detected by an inference model. Accordingly, accuracy of object detection (recognition) by the inference model improves.

An image input to the inference model is optimized by camera control parameters according to the class of the object detected by the inference model. This optimization of the image eliminates the necessity of learning the inference model with use of an inappropriate image, and hence reduces learning data. For example, luminance (exposure amount) of the image input to the inference model is optimized by camera control parameters. This optimization of luminance lowers the necessity of using an image having different luminance as learning data, and hence reduces learning data.

A difference between detection accuracy during learning of the inference model and detection accuracy during inference can be compensated only by adjustment of the camera control parameters. Accordingly, the necessity of relearning of the inference model can be eliminated.

Even when the learning data of the inference model is biased, this bias is absorbable by adjustment of the camera control parameters. Accordingly, the necessity of relearning the inference model can be eliminated.

### (Different Configuration Example 3 of Exposure Control System)

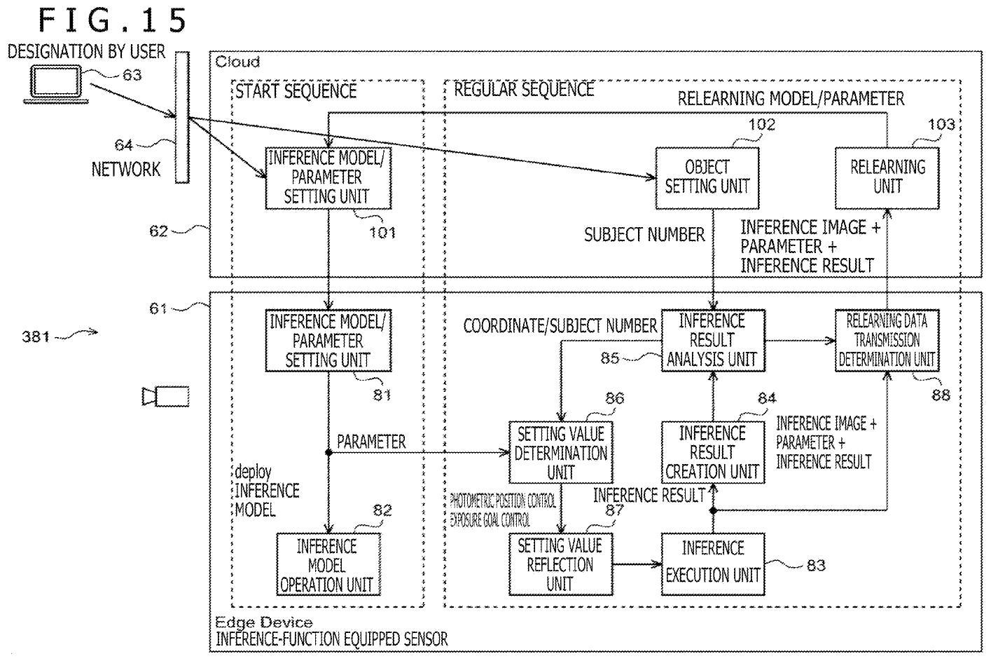

FIG. 15 is a block diagram depicting a different configuration example 3 of the exposure control system. Note that parts depicted in the figure and identical to corresponding parts of the exposure control system 51 in FIG. 2 are given identical reference signs, and are not repeatedly explained.

An exposure control system 381 in FIG. 15 includes the DNN equipped sensor 61, the cloud 62, and the PC 63. The DNN equipped sensor 61 includes the inference model/parameter setting unit 81, the inference model operation unit 82, the inference execution unit 83, the inference result creation unit 84, the inference result analysis unit 85, the setting value determination unit 86, the setting value reflection unit 87, and the relearning data transmission determination unit 88. The cloud 62 includes the inference model/parameter saving unit 101, the object setting unit 102, and the relearning unit 103.

Accordingly, the exposure control system 381 in FIG. 15 is similar to the exposure control system 51 in FIG. 2 in that the DNN equipped sensor 61, the cloud 62, and the PC 63 are provided, that the DNN equipped sensor 61 includes the inference model/parameter setting unit 81, the inference model operation unit 82, the inference execution unit 83, the inference result creation unit 84, the inference result analysis unit 85, the setting value determination unit 86, the setting value reflection unit 87, and the relearning data transmission determination unit 88, and that the cloud 62 includes the inference model/parameter saving unit 101, the object setting unit 102, and the relearning unit 103. However, the exposure control system 381 in FIG. 15 is different from the system in FIG. 2 in that the relearning data transmission determination unit 88 of the DNN equipped sensor 61 acquires, from the inference execution unit 83, an inference result obtained by an inference model as an output from the inference execution unit 83.

According to the exposure control system 381 in FIG. 15, an output (inference result) obtained by an inference model from the inference execution unit 83 is transmitted to the relearning unit 103 of the cloud 62 as relearning data. Accordingly, the inference result obtained by the inference model and output from the inference execution unit 83 is available as learning data without change.

According to the exposure control system 381, similarly to the exposure control system 51 in FIG. 2, the DNN equipped sensor 61 performs camera control suited for detection of an object belonging to a corresponding class, according to each class (type) of objects detected by an inference model. Accordingly, accuracy of object detection (recognition) by the inference model improves.

An image input to the inference model is optimized by camera control parameters according to the class of the object detected by the inference model. This optimization of the image eliminates the necessity of learning the inference model with use of an inappropriate image, and hence reduces learning data. For example, luminance (exposure amount) of the image input to the inference model is optimized by camera control parameters. This optimization of luminance lowers the necessity of using an image having different luminance as learning data, and hence reduces learning data.

A difference between detection accuracy during learning of the inference model and detection accuracy during inference can be compensated only by adjustment of the camera control parameters. Accordingly, the necessity of relearning the inference model can be eliminated.

Even when the learning data of the inference model is biased, this bias is absorbable by adjustment of the camera control parameters. Accordingly, the necessity of relearning the inference model can be eliminated.

### <Program>

A part or all of a series of foregoing processes performed by the DNN equipped sensor 61, the cloud 62, and the like in the exposure control system 51 may be executed either by hardware or by software. In a case where the series of processes are executed by software, a program constituting this software is installed in a computer. The computer here includes a computer incorporated in dedicated hardware, a computer capable of executing various functions under various programs installed in the computer, such as a general-purpose computer, and other computers.

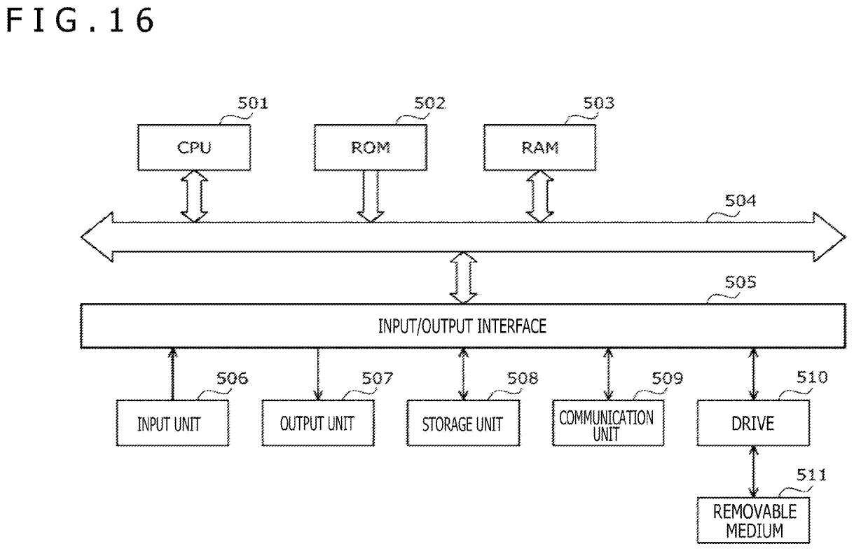

FIG. 16 is a block diagram depicting a configuration example of hardware of a computer which executes the series of processes described above under a program.

In the computer, a CPU (Central Processing Unit) 501, a ROM (Read Only Memory) 502, and a RAM (Random Access Memory) 503 are connected to each other via a bus 504.

An input/output interface 505 is further connected to the bus 504. An input unit 506, an output unit 507, a storage unit 508, a communication unit 509, and a drive 510 are connected to the input/output interface 505.

The input unit 506 includes a keyboard, a mouse, a microphone, and others. The output unit 507 includes a display, a speaker, and others. The storage unit 508 includes a hard disk, a non-volatile memory, and others. The communication unit 509 includes a network interface and others. The drive 510 drives a removable medium 511 such as a magnetic disk, an optical disk, a magneto-optical disk, and a semiconductor memory.

According to the computer configured as above, the CPU 501 loads a program stored in the storage unit 508 to the RAM 503 via the input/output interface 505 and the bus 504, and executes the loaded program to perform the series of processes described above, for example.

The program executed by the computer (CPU 501) may be recorded in the removable medium 511 such as a package medium, and provided in this form, for example. Alternatively, the program may be provided via a wired or wireless transfer medium such as a local area network, the Internet, and digital satellite broadcasting.

In the computer, the program may be installed in the storage unit 508 via the input/output interface 505 from the removable medium 511 attached to the drive 510. Alternatively, the program may be received by the communication unit 509 via a wired or wireless transfer medium, and installed in the storage unit 508. Instead, the program may be installed in the ROM 502 or the storage unit 508 beforehand.

Note that the program executed by the computer may be a program where processes are performed in time series in an order described in the present description, or may be a program where processes are performed in parallel or at a necessary timing, such as an occasion when a call is made.

The present technology may also have the following configurations.

(1)

An information processing device including: a processing unit that changes at least either a parameter associated with imaging or a parameter associated with signal processing for an input image obtained by the imaging, according to a type of an object detected from the input image by an inference model that uses a neural network.

(2)

The information processing device according to (1) above, in which the parameter associated with the imaging is a parameter associated with exposure control.

(3)

The information processing device according to (1) or (2) above, in which the parameter associated with the imaging includes at least either a parameter associated with a photometric area or a parameter associated with an exposure amount.

(4)

The information processing device according to any one of (1) to (3) above, in which the parameter associated with the signal processing includes at least any one of a parameter associated with color correction, a parameter associated with gain, and a parameter associated with noise reduction.

(5)

The information processing device according to (3) above, in which the parameter associated with the photometric area is a size magnification ratio of the photometric area to a detection region of the object detected by the inference model.

(6)

The information processing device according to (3) above, in which the parameter associated with the exposure amount is a goal value of the exposure amount of the photometric area.

(7)

The information processing device according to any one of (1) to (6) above, in which the processing unit sets the parameter corresponding to a type of the object that is a specific object determined beforehand, in a case where multiple types of the objects are detected by the inference model.

(8)

The information processing device according to (7) above, in which the processing unit designates, as the type of the specific object, a type of the object that is an object specified by a user.

(9)

The information processing device according to (2) above, in which the exposure control is achieved by control of at least one of an exposure time, an aperture value, and gain.

(10)

The information processing device according to any one of (1) to (9) above, further including:

an adjustment unit that adjusts the parameters in reference to an inference result obtained by the inference model.

(11)

The information processing device according to (10) above, in which the adjustment unit adjusts the parameters such that a probability that the object detected by the inference model is of the type detected by the inference model rises.

(12)

The information processing device according to any one of (1) to (11) above, further including:

a relearning unit that achieves relearning of the inference model in reference to an inference result obtained by the inference model.

(13)

The information processing device according to (12) above, in which the relearning unit achieves relearning of the inference model by using the input image.

(14)

An information processing method for an information processing device that includes a processing unit, including:

by the processing unit, changing at least either a parameter associated with imaging or a parameter associated with signal processing for an input image obtained by the imaging, according to a type of an object detected from the input image by an inference model that uses a neural network.

(15)

A program that causes a computer to function as a processing unit that changes at least either a parameter associated with imaging or a parameter associated with signal processing for an input image obtained by the imaging, according to a type of an object detected from the input image by an inference model that uses a neural network.

### REFERENCE SIGNS LIST

2: Imaging device
21: Imaging unit
31: CPU
32: DSP
51: Exposure control system
62: Cloud
63: Personal computer
81: Parameter setting unit
82: Inference model operation unit
83: Inference execution unit
84: Inference result creation unit
85: Inference result analysis unit
86: Setting value determination unit
87: Setting value reflection unit
88: Relearning data transmission determination unit
101: Parameter saving unit
102: Object setting unit
103: Relearning unit

1. An information processing device comprising:
a processing unit that changes at least either a parameter associated with imaging or a parameter associated with signal processing for an input image obtained by the imaging, according to a type of an object detected from the input image by an inference model that uses a neural network.

2. The information processing device according to claim 1, wherein the parameter associated with the imaging is a parameter associated with exposure control.

3. The information processing device according to claim 1, wherein the parameter associated with the imaging includes at least either a parameter associated with a photometric area or a parameter associated with an exposure amount.

4. The information processing device according to claim 1, wherein the parameter associated with the signal processing includes at least any one of a parameter associated with color correction, a parameter associated with gain, and a parameter associated with noise reduction.

5. The information processing device according to claim 3, wherein the parameter associated with the photometric area is a size magnification ratio of the photometric area to a detection region of the object detected by the inference model.

6. The information processing device according to claim 3, wherein the parameter associated with the exposure amount is a goal value of the exposure amount of the photometric area.

7. The information processing device according to claim 1, wherein the processing unit sets the parameter corresponding to a type of the object that is a specific object determined beforehand, in a case where multiple types of the objects are detected by the inference model.

8. The information processing device according to claim 7, wherein the processing unit designates, as the type of the specific object, a type of the object that is an object specified by a user.

9. The information processing device according to claim 2, wherein the exposure control is achieved by control of at least one of an exposure time, an aperture value, and gain.

10. The information processing device according to claim 1, further comprising:
an adjustment unit that adjusts the parameters in reference to an inference result obtained by the inference model.

11. The information processing device according to claim 10, wherein the adjustment unit adjusts the parameters such that a probability that the object detected by the inference model is of the type detected by the inference model rises.

12. The information processing device according to claim 1, further comprising:
a relearning unit that achieves relearning of the inference model in reference to an inference result obtained by the inference model.

13. The information processing device according to claim 12, wherein the relearning unit achieves relearning of the inference model by using the input image.

14. An information processing method for an information processing device that includes a processing unit, comprising:
by the processing unit, changing at least either a parameter associated with imaging or a parameter associated with signal processing for an input image obtained by the imaging, according to a type of an object detected from the input image by an inference model that uses a neural network.

15. A program that causes a computer to function as a processing unit that changes at least either a parameter associated with imaging or a parameter associated with signal processing for an input image obtained by the imaging, according to a type of an object detected from the input image by an inference model that uses a neural network.
